(19) United States
(12) Patent Application Publication
(10) Pub. No.: US 2025/0329180 A1
(43) Pub. Date: Oct. 23, 2025

(54) KEY-POINT BASED TEXT REGION IDENTIFICATION

(71) Applicant: OPEN TEXT HOLDINGS, INC., Menlo Park, CA (US)

(72) Inventor: Avishek Kumar Shaw, Baidyabati (IN)

(21) Appl. No.: 18/733,591

(22) Filed: Jun. 4, 2024

(30) Foreign Application Priority Data
Apr. 23, 2024 (IN) 202441032035

(51) Int. Cl. G06V 30/146; G06V 30/14; G06V 30/148; G06V 30/18; G06V 30/19; G06V 30/22; G06V 30/414

(52) U.S. Cl. CPC G06V 30/147; G06V 30/1452; G06V 30/153; G06V 30/18; G06V 30/19107; G06V 30/22; G06V 30/414

(57) ABSTRACT

Systems and methods for text localization are provided. Various embodiments of the present technology provide systems and methods for improved text localization algorithms that will help in enhancing the efficiency of text identification algorithms used for recognizing text in scanned documents prior to performing OCR, or other related applications. In some embodiments, regions of interest are identified on an image document indicating locations on the image document where text may be present. Individual words in the image document are identified based on space identification and region of interest clustering algorithms applied to the regions of interest in the image document.

### CROSS-REFERENCE TO RELATED APPLICATIONS

This application claims a benefit of priority from Indian Patent Application number 202441032035, filed Apr. 23, 2024, entitled “KEY-POINT BASED TEXT REGION IDENTIFICATION,” the contents of which are fully incorporated by reference herein for all purposes.

### TECHNICAL FIELD

This disclosure relates generally to text region identification. In particular, this disclosure relates to systems and methods for identifying and isolating words or regions of interest in images.

### BACKGROUND

When performing some functions, for example, optical character recognition (OCR), one goal is to extract meaningful information from an image that contains text. Before the character recognition takes place, the OCR system must locate where the text is in the image. This may involve identifying the bounding boxes or regions that encompass the text elements, such as words, sentences, paragraphs, or other items containing text. Text localization, in the context of OCR, refers to the process of identifying the regions in an image or document where text is present.

Typically, a person can efficiently localize the different regions of interest (e.g., words) in a document/image containing text. However, the adaptation of such competency into an algorithm induces formidable challenges. Therefore, there is a need for improved text localization algorithms that will help in enhancing the efficiency of text identification algorithms used for recognizing text in scanned documents, converting documents into a searchable form, and automating data extraction from scanned images.

### SUMMARY

Systems and methods for text localization are described that, in some embodiments, include receiving an image document containing textual information, identifying regions of interest on the image document indicating locations on the image document where text may be present, clustering the identified regions of interest to determine potential bounding boxes for the identified regions, identifying spaces among the regions of interest to determine gaps between potential words in the regions of interest, and identifying individual words in the image document based on the determined gaps and determined potential bounding boxes of the regions of interest.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 shows examples of extracted lines of handwritten text from a scanned document.

FIG. 2 illustrates exemplary outputs of a text region identification algorithm applied to the input shown in FIG. 1.

FIG. 3 is a block diagram of a text region identification algorithm.

FIGS. 4A and 4B are diagrams showing examples of extracted lines of handwritten text and identified regions of interest.

FIG. 5 is a diagram showing examples of outputs of an ROI clustering algorithm.

FIG. 6A shows the output of the text localization performed by a prior art system.

FIG. 6B shows the output of an ROI identification algorithm.

FIG. 6C shows the output of an ROI clustering algorithm.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present disclosure describes a system and method that provides improved text localization algorithms that will help in enhancing the efficiency of text identification algorithms used for recognizing text in scanned documents prior to performing OCR, or other related applications performed on scanned images. For example, it may be desired to use such text identification algorithms for recognizing text in scanned documents, converting documents into searchable formats, automating data extraction from scanned documents such as invoices, cheques, etc., or numerous other applications. In addition to providing improved inputs to OCR engines, the disclosed text region identification algorithm can be used for other purposes. For example, the text region identification algorithm can be used to extract words from handwritten documents to generate training data for training OCR systems comprising deep learning algorithms. Numerous other applications are also possible, as one skilled in the art would understand.

Generally, as described in detail below, in a process of text identification, a first stage of the process is localizing each word in the given scanned document. Once the words in a document are localized, each word is cropped from the document and is provided to a text identification algorithm for prediction. The accuracy of the text identification algorithm may be directly dependent on the correct text localization process. In some embodiments, a text localization algorithm is provided with an extracted line from a document as an input and generates an output that includes a list of co-ordinates of words (or regions of interest) present in the provided line. These co-ordinates are then used to crop the words from that line.

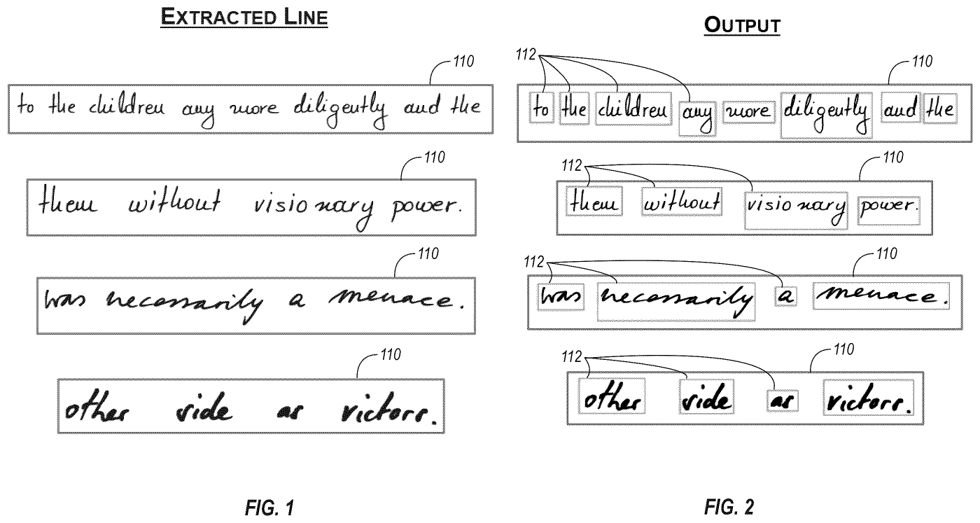

FIG. 1 shows examples of extracted lines 110 of handwritten text from a scanned document. As shown, each extracted line 110 contains, in this example, a line of extracted text, including a series of words. As is described in more detail below, the disclosed text region identification algorithm identifies words in the extracted lines 110, and generates bounding boxes 112 around all of the words or characters present in the line. FIG. 2 shows the extracted lines of FIG. 1, with the bounding boxes determined by the text region identification algorithm. As shown, each word in the extracted lines is localized and identified by the bounding boxes 112. In some embodiments, the identified words can be cropped out, and provided to another process, such as an OCR process, to identify the text. In the exemplary input lines shown in FIG. 1, the extracted lines of text include “to the children any more diligently and the”, “those without visionary power”, “was necessarily a menace”, and “other side as victors”. As shown by the bounding boxes 112 of FIG. 2, each individual word in each of the extracted lines 110 are identified by the bounding boxes 112. For example, for the first extracted line 110, the process has identified the individual words “to”, “the”, “children”, “any”, “more”, “diligently”, “and”, “the”.

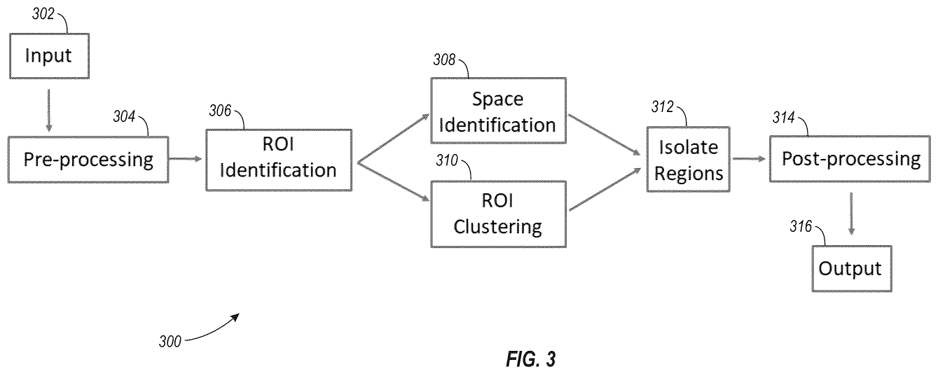

FIG. 3 is a block diagram of an exemplary text region identification algorithm 300. Generally, an image is provided to the algorithm as an input (e.g., an extracted line of text, such as the extracted lines 110 shown in FIG. 1), and the algorithm generates an output (e.g., words identified via bounding boxes, such as the bounding boxes 112 shown in FIG. 2). As shown in FIG. 3, an input 302 is provided to the text region identification algorithm. The input may comprise an image document containing textual information, for example, a scanned image, where it is pre-processed at pre-processing step 304. In some embodiments, the pre-processing step 304 smooths the input image and removes background noise or other outlier information.

After the pre-processing step 304, regions of interest (ROI) are identified (step 306). The ROI identification step 306 can be performed in any desired manner, as one skilled in the art would understand. For example, potential regions of interest containing words or text can be identified using a key-point based algorithm. Any off-the-shelf key-point based algorithm may be used.

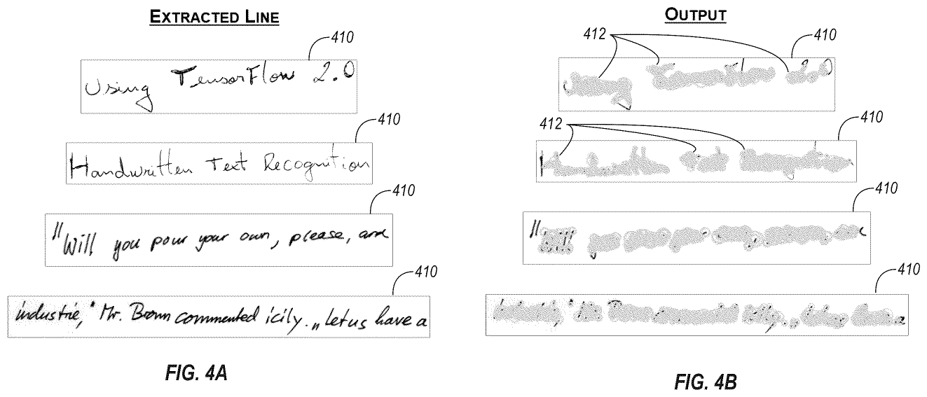

FIGS. 4A and 4B are diagrams showing examples of extracted lines of handwritten text (FIG. 4A) and identified regions of interest (FIG. 4B). FIG. 4A shows four examples of extracted lines 410 of handwritten text from a scanned document (similar to the lines 110 shown in FIG. 1). In this example, lines 410 of extracted text include “Using TensorFlow 2.0”, “Handwritten Text Recognition”, etc. As discussed above, the ROI identification algorithm identifies regions of interest in an input image. In the example of FIG. 4B, ROIs 412 are identified, as illustrated by the shaded areas around the locations on the image of the handwritten words and numbers. Essentially, the output of the ROI algorithm identifies regions on an image where potential text could exist.

After the regions of interest are identified, the text region identification algorithm clusters the identified regions and also identifies spaces (between words) in order to isolate different regions, or words (discussed below). As shown in FIG. 3, the output of the ROI identification step 306 is provided as input to the space identification step 308 and to the ROI clustering step 310. Generally, the space identification step 308 uses the ROI identification information and identifies potential spaces or gaps between adjacent potential words or text. The spaces or gaps can be identified in the extracted lines by looking at the space/distance/etc. between regions, objects, pixels, etc., in an image. Spaces can be detected in other manners as well, as one skilled in the art would understand.

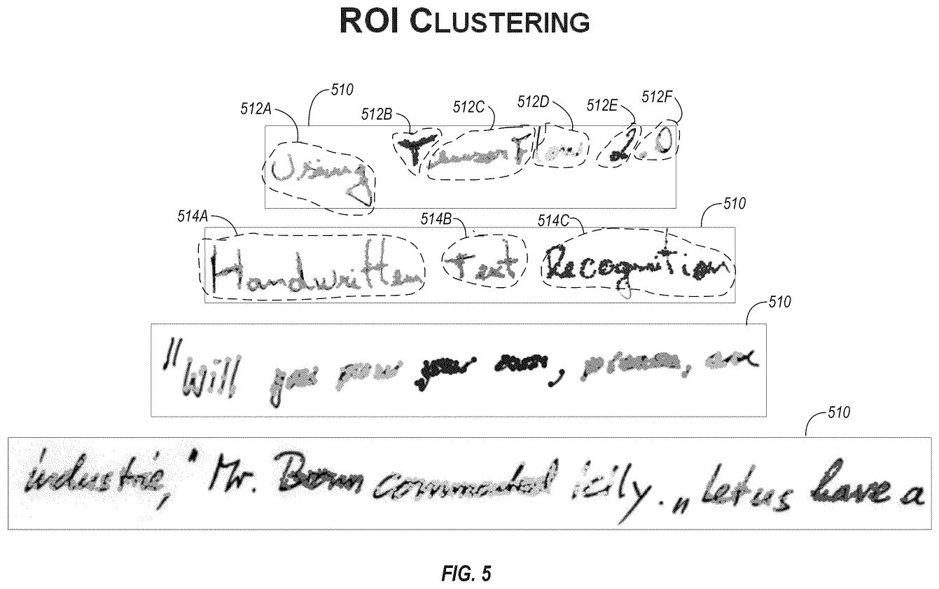

The ROI clustering step 310 uses a clustering algorithm to cluster potential landmark points to identify a potential rectangle (e.g., a bounding box) for an identified region. The ROI clustering step 310 can be achieved using any desired clustering algorithm, including off-the-shelf clustering algorithms, as one skilled in the art would understand. FIG. 5 is a diagram showing examples of outputs of the ROI clustering algorithm (step 310), based on the same inputs (extracted lines of handwritten text) shown in FIG. 4A). The ROI clustering algorithm uses the output of the ROI identification step 306 (e.g., the regions of interest 412 shown in FIG. 4B) to cluster regions into potential bounding boxes. In the first extracted line 510 of handwritten text (“Using TensorFlow 2.0”), the ROI clustering algorithm has clustered the regions of interest into six clusters, as shown by dashed lines and shading around areas of interest. In this example, a first ROI cluster 512A contains the text “Using”. A second ROI cluster 512B corresponds to the text “T”. A third ROI cluster 512C corresponds to the text “ensor F”. A fourth ROI cluster 512D corresponds to the text “low”. A fifth ROI cluster 512E corresponds to the numeral “2”. A sixth ROI cluster 512F corresponds to the numeral “0.0”. Similar clusters are determined for the other extracted lines as well. For example, in the second extracted line 510 of handwritten text (“Handwritten Text Recognition”), the ROI clustering algorithm has clustered the regions of interest into three clusters 514A, 514B, and 514C, as shown by dashed lines and shading around areas of interest.

As shown in these examples, the ROI clustering algorithm itself may not provide perfect results (e.g., correctly identifying each word), but, with the combination of the identified spaces (step 308), accurate results can be achieved. For example, the space identification algorithm may determine that there is no space between clusters 512B and 512C, and therefore the “T” is part of the same word as the following “ensor”. Similarly, the space identification algorithm may determine that there is no space between the “F” in cluster 512C and the following “low” in cluster 512D, and therefore the text “TensorFlow” is a single word.

From the spaces identified by the space identification algorithm (step 308) and the ROI clustering algorithm (step 310), regions are isolated (step 312). The regions are isolated using potential rectangles (as determined by the ROI clustering algorithm) and potential spaces (as determined by the space identification algorithm).

A subsequent post-processing step 314 involves the removal of the identified regions (if any were found) based on the area of the determined rectangle. The post-processing step 314 may remove any outliers found in the input lines. For example, the post-processing step 314 may remove non-words, such as punctuation marks, full stops, etc., i.e., anything that is not a word. The resulting output 316 thus contains individual words identified by the process, such as the words identified by the bounding boxes 112 shown in FIG. 2. The output 316 can be provided to any desired application, such as an OCR engine.

One advantage of the disclosed text region identification algorithm over conventional systems is that the text region identification algorithm does not require training. In a typical OCR or text identification system, machine learning models or deep learning algorithms are used, which require extensive training and re-training. While the disclosed text region identification algorithm can be used to improve such systems, the text region identification algorithm itself does not require training. In addition, with many typical conventional systems designed for handwritten text, the systems may need to be trained separately for different sources of text, different styles of writing, or for different people. In contrast, the disclosed text region identification algorithm does not need to be trained or configured separately for different sources of text. As discussed in detail above, the disclosed text region identification algorithm extracts words (or a region of interest) in a line of handwritten text using a combination of a key-point based algorithm (ROI identification) with space identification and ROI clustering algorithms. Eliminating the need for extensive training and re-training or using complicated ML systems will make a resulting system operate in a more efficient and timely manner, since resources do not need to be dedicated to vast input and training data, complicated ML systems, etc.

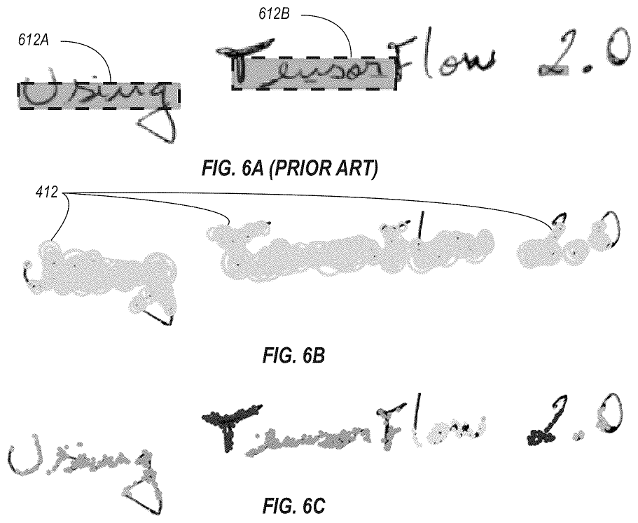

The text region identification algorithm such as that illustrated in FIG. 3 can provide a significant improvement over conventional systems. For example, docTR Document Text Recognition is a popular OCR tool using a two-stage approach—text detection (localization), and then text recognition. While docTR works well for machine generated text, the disclosed text region identification algorithm provides a significant improvement when used on handwritten text. FIGS. 6A-6C show examples illustrating the improvements of the disclosed algorithms.

In FIGS. 6A-6C, the example extracted line discussed above (“Using TensorFlow 2.0”) was applied to the disclosed text region identification algorithm, as well as to the text localization used by docTR.

FIG. 6A shows the output of the text localization performed by docTR. As shown, two regions 612A and 612B were identified by the prior art method. While the prior art identified the region corresponding to the word “Using”, the regions corresponding to the text “Flow” and “2.0” were not identified at all, and the region corresponding to the text “TensorFlow” was only partially identified.

In contrast, as discussed in detail above, the disclosed text region identification algorithm more accurately identified the regions. Note that, in FIGS. 6B and 6C, for clarity, the same numerals are used that were used in the previous Figures. FIG. 6B shows the output of the ROI identification step 306. This output is described above in detail with respect to the first output shown in FIG. 4B. FIG. 6C shows the output of the ROI clustering algorithm 310. As discussed in detail above, the outputs of the space identification algorithm (step 308) and the ROI clustering algorithm 310 are both used to generate an output similar to that shown in FIG. 2, where individual words in an extracted line are identified. A significant improvement over the prior art is evident by comparing the text localization result of a prior art system (FIG. 6A) with the results achievable using the disclosed text region identification algorithm.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of text localization, comprising:
receiving an image document containing textual information;
identifying regions of interest on the image document indicating locations on the image document where text may be present;
clustering the identified regions of interest to determine potential bounding boxes for the identified regions;
identifying spaces among the regions of interest to determine gaps between potential words in the regions of interest; and
identifying individual words in the image document based on the determined gaps and determined potential bounding boxes of the regions of interest.

2. The method of claim 1, wherein the identified regions of interest on the image document are identified using a key-point based algorithm.

3. The method of claim 1, further comprising extracting one or more lines of text from the image document.

4. The method of claim 3, wherein the regions of interest on the image document are identified from one of the one or more lines of text from the image document.

5. The method of claim 4, wherein identifying regions of interest on the image document comprises identifying regions of interest from each of the one or more lines of text from the image document.

6. The method of claim 1, wherein the textual information comprises handwritten text.

7. The method of claim 1, further comprising defining bounding boxes around the identified individual words in the image document.

8. A system for providing text localization, the system comprising:
a processor; and
a non-transitory computer readable medium storing instructions translatable by the processor, the instructions when translated by the processor perform:
receiving an image document containing textual information;
identifying regions of interest on the image document indicating locations on the image document where text may be present;
clustering the identified regions of interest to determine potential bounding boxes for the identified regions;
identifying spaces among the regions of interest to determine gaps between potential words in the regions of interest;
identifying individual words in the image document based on the determined gaps and determined potential bounding boxes of the regions of interest.

9. The system of claim 8, wherein the identified regions of interest on the image document are identified using a key-point based algorithm.

10. The system of claim 8, wherein the instructions further comprise extracting one or more lines of text from the image document.

11. The system of claim 10, wherein the regions of interest on the image document are identified from one of the one or more lines of text from the image document.

12. The system of claim 11, wherein identifying regions of interest on the image document comprises identifying regions of interest from each of the one or more lines of text from the image document.

13. The system of claim 8, wherein the textual information comprises handwritten text.

14. The system of claim 8, wherein the instructions further comprise defining bounding boxes around the identified individual words in the image document.

15. A computer program product comprising a non-transitory computer readable medium storing instructions translatable by a processor, the instructions when translated by the processor perform, in an enterprise computing network environment:
receive an image document containing textual information;
identify regions of interest on the image document indicating locations on the image document where text may be present;
cluster the identified regions of interest to determine potential bounding boxes for the identified regions;
identify spaces among the regions of interest to determine gaps between potential words in the regions of interest; and
identify individual words in the image document based on the determined gaps and determined potential bounding boxes of the regions of interest.

16. The computer program product of claim 15, wherein the identified regions of interest on the image document are identified using a key-point based algorithm.

17. The computer program product of claim 15, wherein the instructions further comprise extracting one or more lines of text from the image document.

18. The computer program product of claim 17, wherein the regions of interest on the image document are identified from one of the one or more lines of text from the image document.

19. The computer program product of claim 18, wherein identifying regions of interest on the image document comprises identifying regions of interest from each of the one or more lines of text from the image document.

20. The computer program product of claim 15, wherein the textual information comprises handwritten text.
